(19) United States
(12) Patent Application Publication
(10) Pub. No.: US 2013/0209201 A1
(43) Pub. Date: Aug. 15, 2013

(54) CARRIER DEVICE

(71) Applicant: KABUSHIKI KAISHA YASKAWA DENKI, (US)

(72) Inventors: Masatoshi FURUICHI, Kitakyushu-shi (JP); Kazunori HINO, Kitakyushu-shi (JP)

(73) Assignee: KABUSHIKI KAISHA YASKAWA DENKI, Kitakyushu-shi (JP)

(21) Appl. No.: 13/742,351

(22) Filed: Jan. 16, 2013

(30) Foreign Application Priority Data
Feb. 13, 2012 (JP) 2012-028796

(51) Int. Cl. B65G 49/00

(52) U.S. Cl. CPC B65G 49/00
USPC 414/226.05

(57) ABSTRACT

A carrier device according to embodiments includes a carrier chamber that is provided with a plurality of connecting holes that are communicated with the outside, an articulated robot that is placed inside the carrier chamber, and a linear moving mechanism that makes at least the arm part of the articulated robot linearly move in a short side direction of the carrier chamber. The bottom end of the arm part of the articulated robot is provided on a base via an arm spindle to be rotatable horizontally and its leading end is provided with a hand that is rotatable horizontally and holds a board to be taken in and out via the connecting holes.

### CROSS-REFERENCE TO RELATED APPLICATION

This application is based upon and claims the benefit of priority of the prior Japanese Patent Application No. 2012-028796, filed on Feb. 13, 2012, the entire contents of which are incorporated herein by reference.

### FIELD

The embodiments discussed herein are directed to a carrier device.

### BACKGROUND

There is known a conventional carrier device that places an articulated carrier robot, which carries a board for a semiconductor wafer or a liquid crystal panel, in a carrier chamber called EFEM (Equipment Front End Module).

The carrier chamber of the conventional carrier device has a shape of a substantially rectangular solid by being surrounded by walls. The longitudinal-side wall that constitutes a part of a peripheral wall is provided with a plurality of connecting holes that are communicated with the outside. A storage vessel and a process chamber of the board are communicated with each other via the connecting holes.

The articulated robot placed in the carrier chamber is generally provided close to a one side wall of the carrier chamber. Herein, a general articulated robot includes an arm part that includes a first arm whose bottom end is connected on a base via a first spindle and a second arm whose bottom end is connected to the leading end of the first arm via a second spindle and whose leading end is provided with a hand. The articulated robot drives the arm part and the hand to make the hand access a storage vessel and a process chamber.

The conventional technology has been known as disclosed in, for example, Japanese Laid-open Patent Publication No. 2008-28134.

However, when the conventional carrier device makes the hand access a storage vessel and a process chamber located at a position close to the turning center of the first arm, an angular velocity around the first spindle becomes large because its distance is short. Therefore, when moving the hand to the position close to the turning center of the first arm, a turning speed must be suppressed, and consequently the number of sheets to be carried by the carrier device (throughput) is not increased.

### SUMMARY

A carrier device according to an aspect of an embodiment includes a carrier chamber that is provided with a plurality of connecting holes that are communicated with an outside, an articulated robot that is placed inside the carrier chamber, and a linear moving mechanism that makes at least the arm part of the articulated robot linearly move in a short side direction of the carrier chamber. The carrier chamber has a substantially rectangular-solid board carrying space surrounded by walls and is provided with the plurality of connecting holes that are formed in longitudinal-side walls of peripheral walls. The bottom end of the arm part of the articulated robot is provided on a base via an arm spindle to be rotatable horizontally and its leading end is provided with a hand that is rotatable horizontally and holds a board to be taken in and out via the connecting holes.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic plan view of a carrier device according to an embodiment;

FIG. 2 is a schematic side view of the carrier device;

FIG. 3 is a schematic explanation diagram of an articulated robot included in the carrier device;

FIG. 4 is a block diagram of the carrier device;

FIGS. 5A and 5B are schematic explanation diagrams illustrating an example of a carrying operation of the carrier device;

FIG. 6 is a schematic explanation diagram illustrating an example of a board carrying procedure performed by the carrier device;

FIG. 7 is a schematic explanation diagram illustrating an example of a board carrying procedure performed by the carrier device according to a comparative example;

FIG. 8 is a schematic explanation diagram illustrating an example of a posture of the articulated robot included in the carrier device; and

FIG. 9 is a schematic explanation diagram illustrating an articulated robot included in a carrier device according to another embodiment.

### DESCRIPTION OF EMBODIMENTS

Hereinafter, a carrier device according to embodiments of the present disclosure will be explained in detail with reference to the accompanying drawings. In addition, the embodiments disclosed below are not intended to limit the present invention.

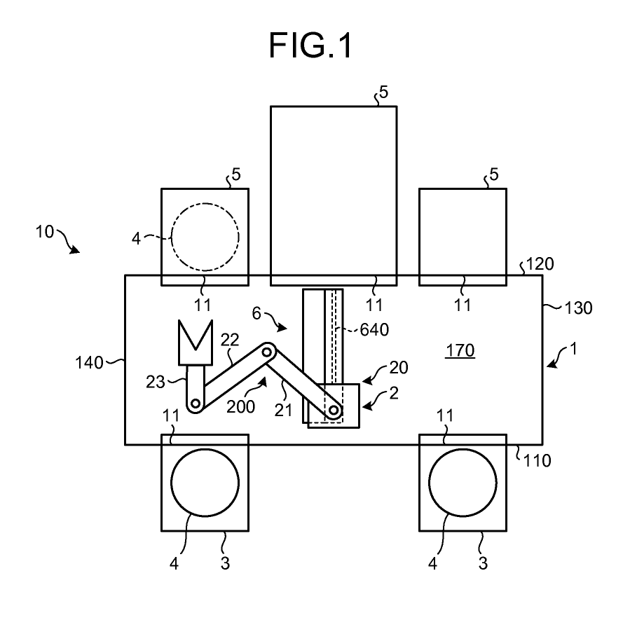

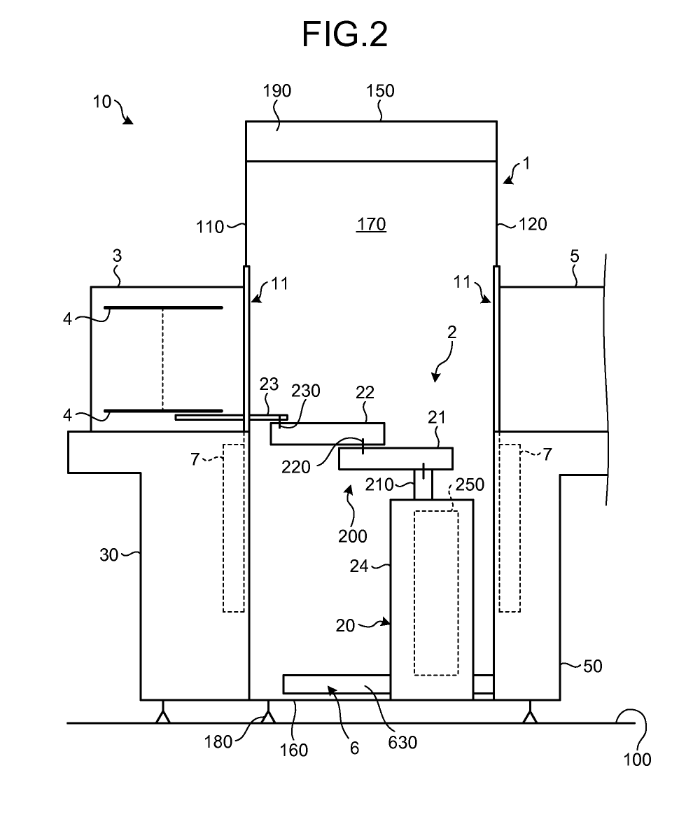

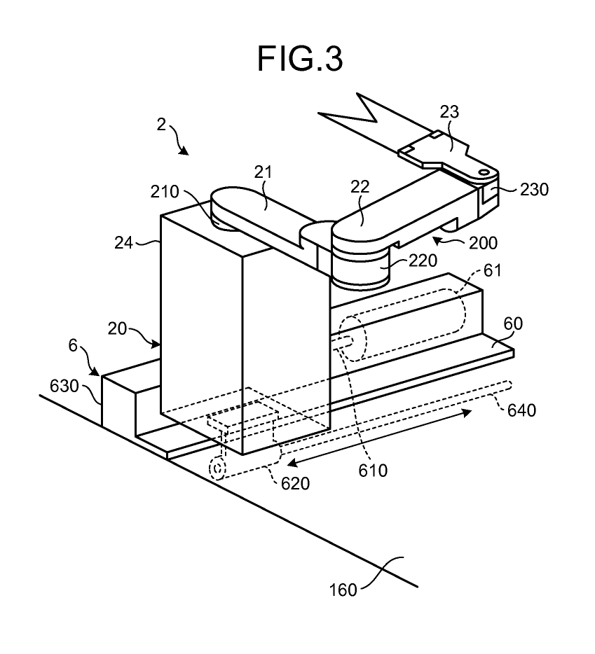

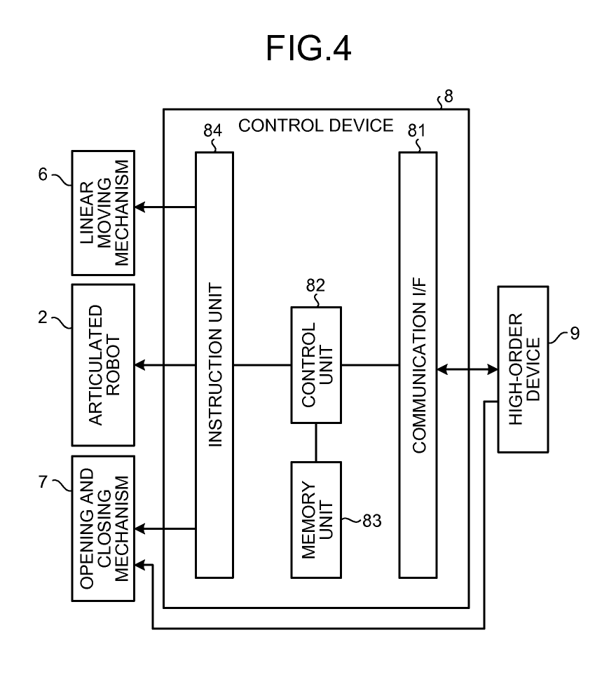

First, a carrier device 10 according to an embodiment will be explained with reference to FIGS. 1 to 4. FIG. 1 is a schematic plan view of the carrier device 10 according to the present embodiment. FIG. 2 is a schematic side view of the carrier device 10. FIG. 3 is a schematic explanation diagram of an articulated robot 2 included in the carrier device 10. FIG. 4 is a block diagram of the carrier device 10.

As illustrated in FIGS. 1 and 2, the carrier device 10 includes a carrier chamber 1 that is provided with a plurality of connecting holes 11 that are communicated with the outside and the articulated robot 2 that is placed in the carrier chamber 1 and can carry a board 4 for a semiconductor wafer or a liquid crystal panel.

The carrier chamber 1 is generally a local clean room called EFEM (Equipment Front End Module) and has a substantially rectangular-solid board carrying space 170 surrounded by walls. The walls consist of a first longitudinal-side wall 110, a second longitudinal-side wall 120, a first short-side wall 130, a second short-side wall 140, a ceiling wall 150, and a floor wall 160. Herein, the first longitudinal-side wall 110, the second longitudinal-side wall 120, the first short-side wall 130, and the second short-side wall 140 may be referred to as peripheral walls. Furthermore, the lower surface of the floor wall 160 is provided with legs 180 that support the carrier chamber 1 on an installation surface 100.

The carrier chamber 1 provides a filter unit 190, which stores therein a filter for purifying gas, inside the ceiling wall 150. The carrier chamber 1 is purified by the filter unit 190 and cleans its inside by using a dropping purified air current, in a state where the carrier chamber is blocked from the outside.

The plurality of connecting holes 11 are provided, on a line, in the first and second longitudinal-side walls 110 and 120 that constitute a part of the peripheral walls of the carrier chamber 1.

In the present embodiment, storage vessels 3, which are called FOUP (Front-Opening Unified Pod) and can store therein the board 4 such as wafers in a multistage manner, are attached to the two connecting holes 11 that are formed in the first longitudinal-side wall 110 at predetermined intervals.

Furthermore, process chambers 5, which perform predetermined processes such as CVD (Chemical Vapor Deposition), exposure, etching, and asking on the board 4, are attached to the three connecting holes 11 formed in the second longitudinal-side wall 120. Herein, the present invention has a configuration that the central process chamber 5 is deeper than the both-side process chambers 5.

The storage vessels 3 and the process chambers 5 are attached to the connecting holes 11 via opening and closing members such as shutters (not illustrated). An opening and closing mechanism 7 (see FIG. 4) that drives the opening and closing members is provided in a storage vessel table 30 that holds the storage vessels 3 and a process chamber table 50 that holds the process chambers 5.

The articulated robot 2 includes an arm part 200 that is provided with a hand 23 that holds the board 4. The bottom end of the arm part 200 is provided on a base 20 via a first arm spindle 210 to be rotatable horizontally and its leading end is provided with the hand 23 to be rotatable horizontally (hereinafter, “horizontal rotation” may be expressed as “turning”). Moreover, the hand 23 can have a configuration that the hand can place thereon and carry the board 4 by employing a fork shape as in the present embodiment, a configuration that the hand can adsorb the board 4, or a configuration that the hand can grip the board 4.

The pillar-shaped first arm spindle 210, which supports the arm part 200, is provided to upward protrude from an arm supporting unit 24 that is provided on the top of the base 20, and is provided to be freely lifted and lowered by a lifting and lowering mechanism 250 placed in the base 20. By employing this configuration, the articulated robot 2 can appropriately lift or lower and turn the arm part 200 to take the board 4 in and out via the connecting hole 11 and to carry the held board 4 at a desired position.

In other words, the articulated robot 2 includes the arm part 200 of which the bottom end is provided to be able to turn on the base 20 via the first arm spindle 210 and the leading end is provided with the hand 23 to be able to turn, which holds the board 4 to be taken in and out via the connecting hole 11.

The arm part 200 includes a first arm 21 and a second arm 22. In other words, the arm part 200 has a configuration that the bottom end of the first arm 21 is connected to the base 20 via the first arm spindle 210 and the bottom end of the second arm 22 is connected to the leading end of the first arm 21 via a second arm spindle 220.

The bottom end of the hand 23 is connected to turn freely to the leading end of the second arm 22 via a hand spindle 230. Moreover, each of the first arm spindle 210, the second arm spindle 220, and the hand spindle 230 is connected to a turning mechanism (not illustrated) that includes a motor, a speed reducer, and the like.

Herein, it is assumed that the articulated robot 2 according to the present embodiment is a one-arm robot that has the one arm part 200 that includes the first arm 21, the second arm 22, and the hand 23. However, the present embodiment is not limited to this. The articulated robot 2 may be a two-arm robot that has the two arm parts 200 or may be a robot that has the three or more arm parts 200.

The two-arm robot can perform two work operations concurrently and simultaneously by taking out the board 4 via the predetermined connecting hole 11 by using the one arm part 200 and also by taking in the new board 4 via this connecting hole 11 by using the other arm part 200.

It has been explained that the articulated robot 2 according to the present embodiment has the single hand 23. However, the articulated robot 2 may have a configuration that a plurality of the hands 23 is provided on the leading end of the second arm 22.

The characteristic configuration of the carrier device 10 according to the present embodiment is that the carrier device 10 includes a linear moving mechanism 6 that can linearly move at least the arm part 200 of the articulated robot 2 in a short side direction of the carrier chamber 1.

As illustrated in FIGS. 1 and 3, the linear moving mechanism 6 according to the present embodiment includes a hydraulic cylinder 61 that acts as a linear actuator and is placed in the substantial center of the floor wall 160 of the carrier chamber 1. As illustrated in FIG. 3, a piston rod 610 of the hydraulic cylinder 61 is connected to a connection adapter 620 that is attached to the center of the lower surface of the base 20 of the articulated robot 2. In other words, the articulated robot 2 is moved along with the base 20 by the drive of the hydraulic cylinder 61. Moreover, the hydraulic cylinder 61 is placed inside a case 630.

A track 60 is provided to cross the carrier chamber 1 in the substantial center of the substantially rectangular carrier chamber 1 when being viewed from the top. The connection adapter 620 connected to the lower surface of the base 20 of the articulated robot 2 linearly moves along the track 60.

By employing this configuration, the articulated robot 2 can be linearly moved to any one of a first working position (see FIG. 1) close to the first longitudinal-side wall 110 and a second working position (see FIG. 2) close to the second longitudinal-side wall 120.

As illustrated in FIG. 4, the carrier device 10 according to the present embodiment includes a control device 8 that performs operation control of the articulated robot 2, which includes rotation operations of the arm part 200, and operation control of the linear moving mechanism 6.

As illustrated in FIG. 4, the control device 8 includes a communication I/F (interface) 81, a control unit 82, a memory unit 83, and an instruction unit 84.

Each drive system of the articulated robot 2, the linear moving mechanism 6, which includes the linear actuator that linearly moves the articulated robot 2, and the opening and closing mechanism 7, which drives the opening and closing member of the storage vessel 3 and the process chamber 5, are connected to the control device 8. Furthermore, a high-order device 9 to be described below is connected to the control device 8 via the communication I/F 81.

Herein, the communication I/F 81 is a device that performs transmission and reception of communication data between the control device 8 and the high-order device 9. For example, in order to update various types of programs stored in the memory unit 83, the communication I/F 81 can receive appropriate data from the high-order device 9.

The memory unit 83 is a device such as RAM (Random Access Memory), ROM (Read Only Memory), and a hard disk. The memory unit 83 stores drive programs of the articulated robot 2, the linear moving mechanism 6, and the opening and closing mechanism 7.

In the carrier device 10 according to the present embodiment, a program according to the first working position and a program according to the second working position are stored as the drive programs of the articulated robot 2.

The control unit 82 includes an arithmetic unit such as a central processing unit (CPU). The control unit 82 outputs driving signals to the articulated robot 2 and the linear moving mechanism 6 or the opening and closing mechanism 7 via the instruction unit 84 in accordance with the drive programs stored in the memory unit 83. Generally, a driving signal for the opening and closing mechanism 7 is output from the high-order device 9.

Furthermore, the control unit 82 computes the positions of predetermined base points on the base 20 and the arm part 200 of the articulated robot 2 and also performs a computation process of a moving distance of the hand 23 up to the storage vessel 3 and the process chamber 5 on the basis of the base points.

In the articulated robot 2 according to the present embodiment, centers of the first arm spindle 210, the second arm spindle 220, and the hand spindle 230 and a center of the board 4 placed on the hand 23 are used as the base points of the arm part 200. An undersurface center of the base 20 is used as the base point of the base 20.

As described above, the control unit 82 computes and manages position information of the articulated robot 2 in order to control the motions of the articulated robot 2.

Then, the control unit 82 controls the linear moving mechanism 6 on the basis of the computation result to selectively move the articulated robot 2 to any one of the first working position (see FIG. 1) and the second working position (see FIG. 2) if needed in such a manner that the board 4 can be carried up to a desired position in the shortest time.

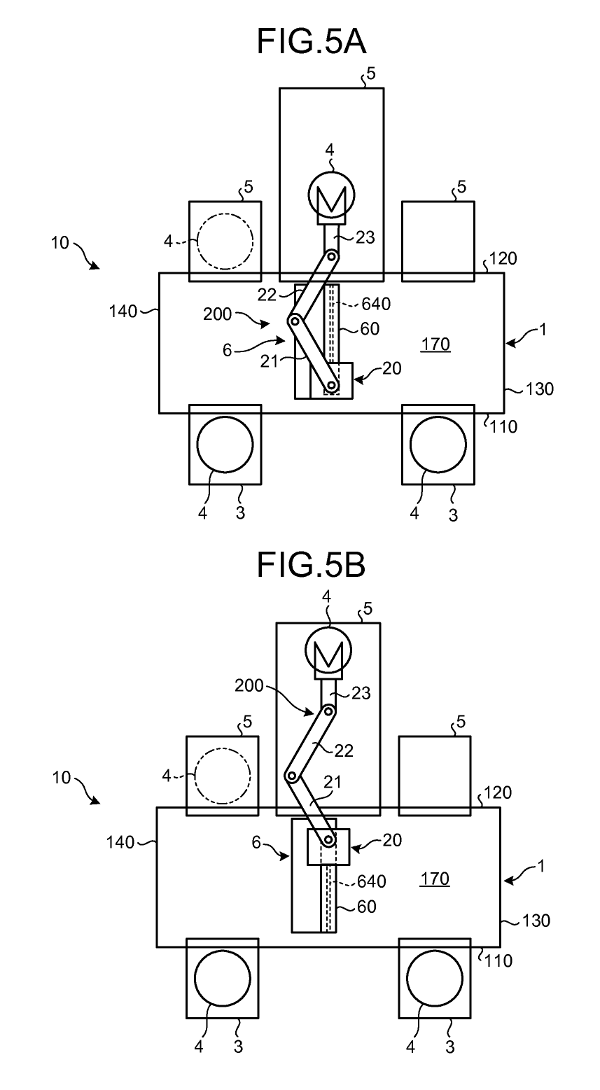

FIGS. 5A and 5B are schematic explanation diagrams illustrating an example of a carrying operation of the carrier device 10. For example, the three process chambers 5 are provided in the carrier device 10 of the present embodiment. As described above, the central process chamber 5 is deeper than the both-side process chambers 5.

In the central process chamber 5, the board 4 must be carried from the position of FIG. 5A to the deeper position as illustrated in FIG. 5B in some cases. However, even in such a case, according to the carrier device 10 of the present embodiment, the board 4 can be carried up to the deeper position by driving the linear moving mechanism 6.

In other words, the articulated robot 2 is moved from the first working position (FIG. 5A) to the second working position (FIG. 5B) without changing the posture of the arm part 200, and thus the board 4 can be carried in a desired depth direction with a simple control.

If the first arm 21, the second arm 22, and the hand 23 have a linear posture by controlling the drive of the arm part 200 at the second working position, the board 4 can be carried up to a further deeper position.

Furthermore, the control unit 82 can determine which of the first working position and the second working position is a position favorable to carrying the board 4 in the shortest time, on the basis of the access position of the hand 23 to the storage vessel 3 or the process chamber 5 and the present position of the articulated robot 2.

In other words, the articulated robot 2 may be maintained at the present position (the first working position or the second working position) or may be moved to the favorable position (the second working position or the first working position), on the basis of the determination result.

Then, the control unit 82 drives the arm part 200 to perform a process for carrying the board 4 in accordance with a drive program corresponding to the first working position or the second working position.

In other words, the control device 8 of the carrier device 10 according to the present embodiment can control the rotation operation of both or one of the first arm 21 and the second arm 22 in accordance with the position of the arm part 200 moved by the linear moving mechanism 6.

In order to compute the position of the base point, the carrier device 10 may include a sensor that detects the positions of the base point of the base 20 and the base points of the arm part 200.

Because the carrier device 10 according to the present embodiment has the configuration described above, the carrier device 10 can perform the process for carrying the board 4 in the state where the articulated robot 2 is moved to the optimum position.

Therefore, even when the hand 23 accesses the storage vessel 3 or the process chamber 5 that is adjacent to the first arm spindle 210 that is the turning center of the first arm 21, the turning speed of the arm part 200 may not be suppressed by moving the articulated robot 2 in a short side direction and backing it away therefrom. As a result, it is possible to contribute to the improvement of the throughput of the carrier device 10, namely, the number of the boards 4 to be carried.

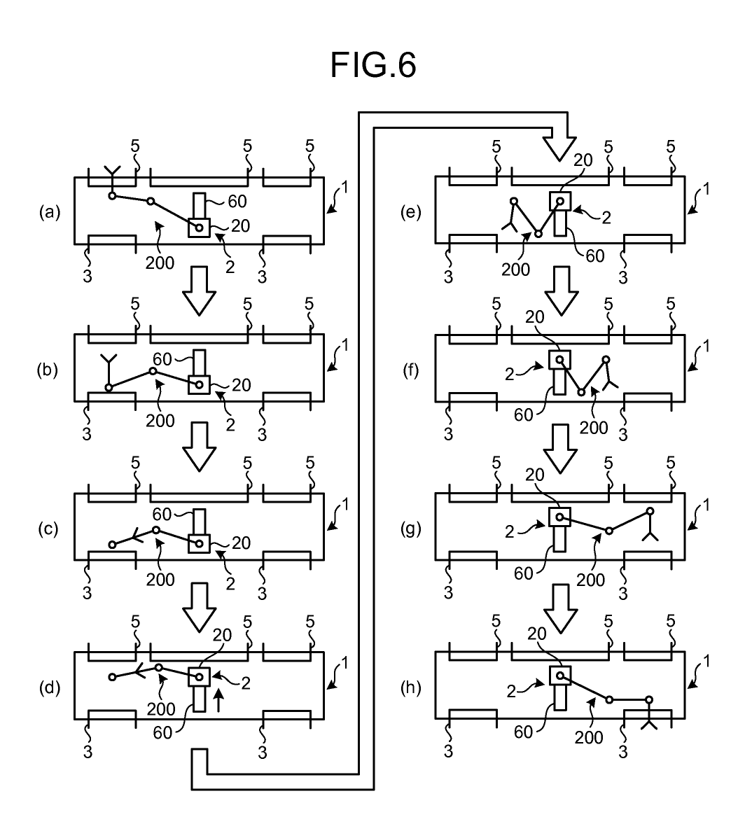

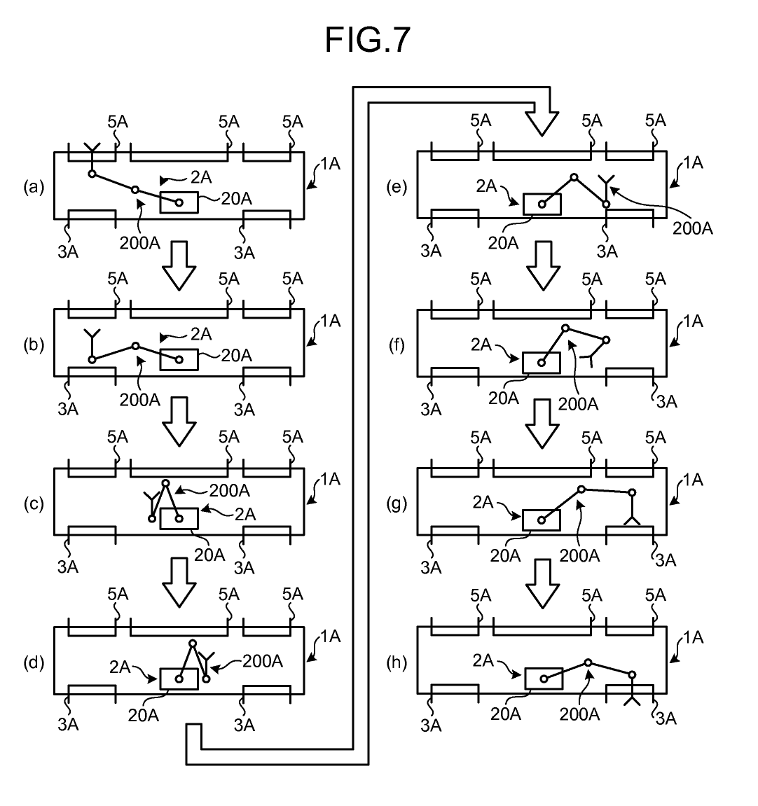

Herein, a favorable point of a board carrying procedure performed by the carrier device 10 according to the present embodiment will be explained with reference to FIGS. 6 and 7. A carrying process is performed by, for example, the procedures of (a) to (h) of FIG. 6 and (a) to (h) of FIG. 7. Moreover, the carrying process is performed in accordance with instructions from the high-order device 9, for example.

FIG. 6 is a schematic explanation diagram illustrating an example of a board carrying procedure performed by the carrier device 10 according to the present embodiment. The carrier device 10 includes the linear moving mechanism 6, which has the track 60, in the carrier chamber 1 to make the articulated robot 2 move in the short side direction of the carrier chamber 1. FIG. 7 is a schematic explanation diagram illustrating an example of a board carrying procedure performed by the carrier device according to a comparative example. The carrier device has a configuration that an articulated robot 2A is fixed inside the carrier chamber 1A.

FIGS. 6 and 7 illustrate a case where a board is carried from the process chamber 5, 5A located at the upper-left side on the drawing to the storage vessel 3, 3A located at the lower-right side on the drawing. Moreover, In the carrier device according to the comparative example of FIG. 7, the same components as those of the carrier device 10 according to the present embodiment have reference numbers, which are obtained by adding “A” to the reference numbers indicating the components of the carrier device 10, or the reference numbers of the same components are omitted. In FIGS. 6 and 7, for the sake of convenience, the board that is being carried is not illustrated and the notations of the reference numbers on the detailed components are omitted. The carrier device 10 illustrated in FIG. 6 has the same configuration as that of FIGS. 1 and 2.

As illustrated in (a) of FIG. 6, the articulated robot 2 is located at the first working position. When a predetermined process on the board is terminated, the articulated robot 2 of the carrier device 10 according to the present embodiment drives the arm part 200 to make the hand 23 access the process chamber 5 and holds the processed board 4. At this time, the hand 23 takes a posture by which the hand directly faces the process chamber 5, the first and second arms 21 and 22 extend substantially linearly, and the arm part 200 has a long state.

Next, the articulated robot 2 appropriately rotates the first and second arms 21 and 22 around the first and second arm spindles 210 and 220 to have the posture of the arm part 200 illustrated in (b) of FIG. 6, and thus the hand 23 is drawn and is moved from the process chamber 5 into the board carrying space 170.

Next, as illustrated in (c) of FIG. 6, the hand 23 is rotated around the hand spindle 230 to be overlapped on the first arm 21. At this time, the arm part 200 is still in a comparatively long state.

Then, as illustrated in (d) of FIG. 6, the carrier device drives the linear moving mechanism 6 without changing the posture and moves the articulated robot 2 up to the second working position along the track 60.

Then, as illustrated in (e) of FIG. 6, the carrier device appropriately rotates the first and second arms 21 and 22 around the first and second arm spindles 210 and 220 and makes the second arm spindle 220 be located near the first longitudinal-side wall 110 of the carrier chamber 1. At this time, the arm part 200 is in a shortened state.

Next, the carrier device rotates the first arm 21 around the first arm spindle 210 and parallel moves the arm part 200 without changing its posture from the second short-side wall side to the first short-side wall side, as illustrated in (f) of FIG. 6.

Next, as illustrated in (g) of FIG. 6, the carrier device appropriately rotates the first and second arms 21 and 22 around the first and second arm spindles 210 and 220 to make the arm part 200 extend and to make the hand 23 have a posture directly facing the storage vessel 3.

Then, as illustrated in (h) of FIG. 6, the carrier device rotates the second arm 22 around the second arm spindle 220, and also inserts the hand 23 into the storage vessel 3 while rotating the hand 23 around the hand spindle 230 and stores thereon the board 4. At this time, the posture of the arm part 200 is symmetric with the posture illustrated in (a) of FIG. 6.

In other words, the movements of turning mechanisms (not illustrated) that drive the first and second arms 21 and 22 and the hand 23 that constitute the arm part 200 are the same in the cases when the hand 23 accesses the process chamber 5 that is located on the upper-left side on the drawing and when the hand 23 accesses the storage vessel 3 that is located on the lower-right side on the drawing. Therefore, the positional accuracies of the arm part 200 driven by the turning mechanisms are substantially constant.

On the other hand, when the carrier device according to the comparative example carries the board from the process chamber 5A located on the upper-left side on the drawing to the storage vessel 3A located on the lower-right side on the drawing, the articulated robot 2A shows the following behaviors.

In other words, the articulated robot 2A in (a) and (b) of FIG. 7 performs the same operations as those of the articulated robot 2 according to the present embodiment. However, after the hand is drawn and is moved from the process chamber 5A into the board carrying space 170, the carrier device largely rotates the first and second arms around the first and second arm spindles to make an arm part 200A shrink as illustrated in (c) of FIG. 7.

Then, the carrier device rotates the first arm around the first arm spindle and parallel moves the arm part 200A without changing its posture from the second short-side wall side to the first short-side wall side as illustrated in (d) of FIG. 7.

Next, as illustrated in (e) of FIG. 7, the carrier device appropriately rotates the first and second arms around the first and second arm spindles to make the arm part 200A extend.

Then, as illustrated in (f) of FIG. 7, the carrier device rotates the first arm around the first arm spindle to make the second arm spindle be located near the second longitudinal-side wall of the carrier chamber 1A, and largely rotates the hand around the hand spindle to make the hand go toward the storage vessel 3A.

Next, as illustrated in (g) of FIG. 7, the carrier device appropriately rotates the first and second arms around the first and second arm spindles to make the arm part extend comparatively and to make the hand have a posture directly facing the storage vessel 3A.

Then, as illustrated in (h) of FIG. 7, the carrier device inserts the hand into the storage vessel 3A and stores thereon the board 4 while rotating the first arm around the first arm spindle and also rotating the hand around the hand spindle. At this time, the posture of the arm part 200A has a chevron design unlike the extended states as illustrated in (a) of FIG. 7 and (a) and (h) of FIG. 6.

In other words, the movements of the turning mechanisms (not illustrated) that drive the first and second arms and the hand that constitute the arm part 200A are different in the cases when the hand accesses the process chamber 5A that is located on the upper-left side on the drawing and when the hand accesses the storage vessel 3A that is located on the lower-right side on the drawing. Therefore, there is a possibility that the movements of belts wound around gears and pulleys that constitute the turning mechanisms have a delicate difference. A positional accuracy of the arm part 200A driven by the turning mechanisms may be lower compared to the carrier device 10 according to the present embodiment.

As described above, even when the carrier device 10 according to the present embodiment makes the hand 23 access any one of the storage vessel 3 and the process chamber 5 facing each other, the carrier device 10 can maintain the access posture of the hand substantially constant by moving the articulated robot 2 in a short side direction. Therefore, the movements of belts wound around gears and pulleys that constitute the turning mechanisms become substantially constant, and thus positional accuracies of the arm part 200 driven by the turning mechanisms become constant.

It has been explained that the articulated robot 2 described above includes the hydraulic cylinder 61 as a linear actuator of the linear moving mechanism 6. The articulated robot 2 may include an air cylinder or may include a ball screw mechanism that is connected to a linear motor, a servo motor, or the like.

In other words, if the drive is performed by the hydraulic cylinder 61 or the air cylinder, the working position (the position of the arm part 200 when at least being viewed from the top) of the articulated robot 2 is defined by any one of the first working position and the second working position. However, if the ball screw mechanism connected to the linear motor, the servo motor, or the like is used, the control device 8 can perform more various position controls.

In other words, the control device 8 controls the linear moving mechanism 6 to be able to move at least the arm part 200 of the articulated robot 2 to an arbitrary position between the first working position close to the first longitudinal-side wall 110 and the second working position close to the second longitudinal-side wall 120.

When such a control is performed, the control device 8 activates the linear moving mechanism 6 and the arm part 200 of the articulated robot 2, namely, the first arm 21, the second arm 22, and the hand 23, to be synchronized with each other.

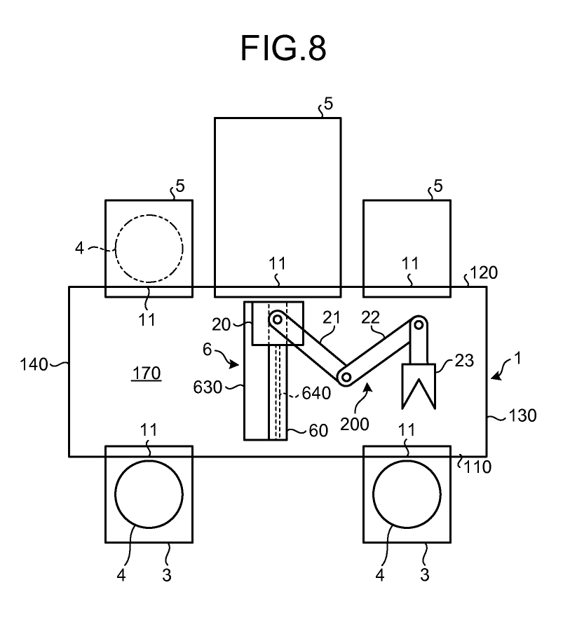

FIG. 8 is a schematic explanation diagram illustrating an example of a posture of the articulated robot 2 according to the present embodiment. It is considered that the posture of the arm part 200 is changed, for example, from the posture illustrated in FIG. 1 to the posture illustrated in FIG. 8 while moving the articulated robot 2 by using the linear moving mechanism 6.

The articulated robot 2 illustrated in FIG. 1 is located at the first working position. As its posture, the leading end of the first arm 21 and the leading end of the hand 23 are located at a more front side than the base 20, namely, toward the second working position.

Therefore, upon driving the linear moving mechanism 6 without changing the posture, because the leading end of the hand 23 collides against the second longitudinal-side wall 120, the control device 8 rotates the first arm 21, the second arm 22, and the hand 23 that constitute the arm part 200 while synchronizing them. Then, the control device 8 simultaneously controls the moving speed of the articulated robot 2 by the linear moving mechanism 6.

In other words, the control device 8 appropriately changes the posture of the arm part 200 while moving the articulated robot 2 from the state of FIG. 1 to the state of FIG. 8 to control the movement of the arm part 200 in such a manner that the arm part 200 does not interfere with the peripheral wall of the carrier chamber 1.

### Another Embodiment

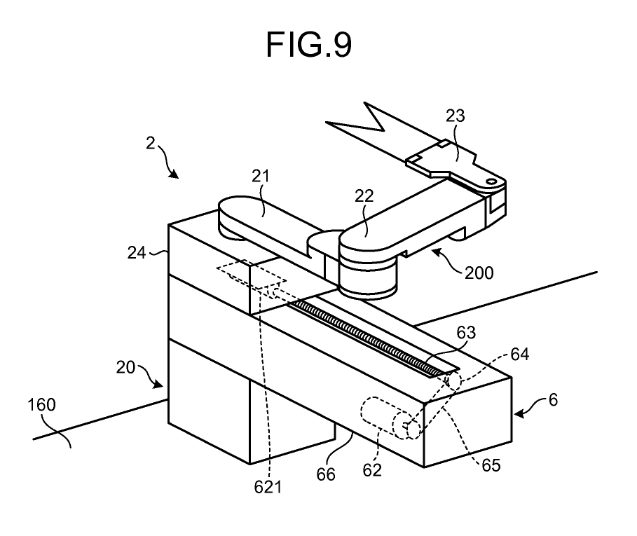

FIG. 9 is a schematic explanation diagram of the articulated robot 2 included in the carrier device 10 according to another embodiment. In the other embodiment, components having the same function and configuration as those of the above embodiment have the same reference numbers and their explanations are omitted.

The other embodiment has a configuration that the articulated robot 2 illustrated in FIG. 9 includes, as the linear moving mechanism 6, a linear actuator coupled to the arm part 200 between the base 20 and the arm part 200, and only the arm part 200 is moved.

In the other embodiment, the arm part 200 cannot be lifted and lowered, and the arm supporting unit 24 to which the arm spindle 210 is connected to turn freely is provided to be separated from the base 20 fixed on the floor wall 160 of the carrier chamber 1. Then, the arm supporting unit 24 is provided on the base 20 while placing the linear moving mechanism 6 therebetween. In other words, the linear moving mechanism 6, which stores a linear actuator in the rectangular solid-shaped case 66 that extends in the short side direction of the carrier chamber 1, is placed on the base 20, and the linear actuator and the arm supporting unit 24 are connected to each other.

As described above, in the other embodiment, the arm part 200 means that the arm part 200 includes the arm supporting unit 24 that supports the arm part 200. By the drive of the linear actuator, only the arm part 200 is moved along with the arm supporting unit 24 in the state where the base 20 is fixed. Moreover, even if the arm part 200 may be lifted and lowered, the arm supporting unit 24 that stores therein the lifting and lowering mechanism 250 can be placed on the base 20 via the linear moving mechanism 6 if an amount of lifting of the arm part 200 is small and the lifting and lowering mechanism 250 is compact, for example.

Similarly to the above embodiment, a hydraulic cylinder, an air cylinder, or a ball screw mechanism using a linear motor or a servo motor is used as the linear actuator. In the other embodiment, a ball screw mechanism that employs a driving motor 62 that includes a servo motor is used as the linear actuator.

The ball screw mechanism includes a ball screw shaft 63 that extends in the longitudinal direction of the case 66 and the driving motor 62 that is connected to a pulley 64 provided on one end of the ball screw shaft 63 via a timing belt 65.

A female screw of a connection adapter 621 is threadedly engaged with the ball screw shaft 63, and the connection adapter 621 and the arm supporting unit 24 are connected to each other. In this way, upon rotating the ball screw shaft 63 by using the driving motor 62, the arm part 200 is moved onto the ball screw shaft 63 via the connection adapter 621 and the arm supporting unit 24. In other words, although the base 20 is fixed at, for example, the first working position, the arm part 200 is moved to an arbitrary position between the first working position and the second working position along with the arm supporting unit 24 upon activating the linear moving mechanism 6 by the control device 8.

Even in the other embodiment, the board 4 can be carried up to the further deeper position than the conventional position by a simple control for moving the arm part 200 between the first working position and the second working position.

Even when the hand 23 accesses the storage vessel 3 or the process chamber 5 adjacent to the first arm spindle 210 that is the turning center of the first arm 21, the turning speed of the arm part 200 may not be suppressed because the arm part 200 can be moved in a short side direction and be backed away therefrom. In other words, it is possible to contribute to the improvement of the number of the boards (throughput) to be carried by the carrier device 10.

Furthermore, even when the hand 23 accesses any one of the storage vessel 3 and the process chamber 5 facing each other, the access posture of the arm part 200 can be substantially constant by moving the arm part 200 in the short side direction. Therefore, the movements of belts wound around gears and pulleys that constitute the turning mechanisms of the arm part 200 become substantially constant, and thus positional accuracies of the arm part 200 become constant.

The configuration of the articulated robot 2 of the carrier device 10 and the configuration and arrangement of the linear moving mechanism 6 are not limited to the embodiments described above.

Furthermore, the shape and form of the carrier chamber 1 of the carrier device 10 and the storage vessel 3 and the process chamber 5 consisting of FOUP that are connected to the carrier chamber are not limited to the configurations of the embodiments described above. If they have a structure based on a SEMI (Semiconductor Equipment and Materials International) standard, for example, they can be appropriately selected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A carrier device comprising:
a carrier chamber that has a substantially rectangular-solid board carrying space surrounded by walls and is provided with a plurality of connecting holes that are communicated with an outside and are formed in longitudinal-side walls of peripheral walls;
an articulated robot that is placed inside the carrier chamber and includes an arm part whose bottom end is provided on a base via an arm spindle to be rotatable horizontally and leading end is provided with a hand that is rotatable horizontally and holds a board to be taken in and out via the connecting holes; and
a linear moving mechanism that makes at least the arm part of the articulated robot linearly move in a short side direction of the carrier chamber.

2. The carrier device according to claim 1, further comprising a control device that performs an operation control of the articulated robot including a rotation operation of the arm part and an operation control of the linear moving mechanism.

3. The carrier device according to claim 2, wherein the control device controls the linear moving mechanism to make at least the arm part of the articulated robot selectively move to any one of a first working position close to a first longitudinal-side wall and a second working position close to a second longitudinal-side wall.

4. The carrier device according to claim 2, wherein the control device controls the linear moving mechanism to make at least the arm part of the articulated robot move to an arbitrary position between a first working position close to a first longitudinal-side wall and a second working position close to a second longitudinal-side wall.

5. The carrier device according to claim 2, wherein the arm part includes:
a first arm whose bottom end is connected onto the base via a first spindle; and
a second arm whose bottom end is connected to a leading end of the first arm via a second spindle and leading end is provided with a hand, and
the control device controls a rotation operation of both or one of the first arm and the second arm in accordance with a position of the arm part moved by the linear moving mechanism.

6. The carrier device according to claim 3, wherein the arm part includes:
a first arm whose bottom end is connected onto the base via a first spindle; and
a second arm whose bottom end is connected to a leading end of the first arm via a second spindle and leading end is provided with a hand, and
the control device controls a rotation operation of both or one of the first arm and the second arm in accordance with a position of the arm part moved by the linear moving mechanism.

7. The carrier device according to claim 4, wherein the arm part includes:
a first arm whose bottom end is connected onto the base via a first spindle; and
a second arm whose bottom end is connected to a leading end of the first arm via a second spindle and leading end is provided with a hand, and
the control device controls a rotation operation of both or one of the first arm and the second arm in accordance with a position of the arm part moved by the linear moving mechanism.

8. The carrier device according to claim 1, wherein the linear moving mechanism includes a linear actuator connected to the base and moves the articulated robot along with the base.

9. The carrier device according to claim 2, wherein the linear moving mechanism includes a linear actuator connected to the base and moves the articulated robot along with the base.

10. The carrier device according to claim 3, wherein the linear moving mechanism includes a linear actuator connected to the base and moves the articulated robot along with the base.

11. The carrier device according to claim 4, wherein the linear moving mechanism includes a linear actuator connected to the base and moves the articulated robot along with the base.

12. The carrier device according to claim 5, wherein the linear moving mechanism includes a linear actuator connected to the base and moves the articulated robot along with the base.

13. The carrier device according to claim 6, wherein the linear moving mechanism includes a linear actuator connected to the base and moves the articulated robot along with the base.

14. The carrier device according to claim 7, wherein the linear moving mechanism includes a linear actuator connected to the base and moves the articulated robot along with the base.

15. The carrier device according to claim 1, wherein the linear moving mechanism includes a linear actuator connected to the arm part between the base and the arm part of the articulated robot and moves only the arm part.

16. The carrier device according to claim 2, wherein the linear moving mechanism includes a linear actuator connected to the arm part between the base and the arm part of the articulated robot and moves only the arm part.

17. The carrier device according to claim 3, wherein the linear moving mechanism includes a linear actuator connected to the arm part between the base and the arm part of the articulated robot and moves only the arm part.

18. The carrier device according to claim 4, wherein the linear moving mechanism includes a linear actuator connected to the arm part between the base and the arm part of the articulated robot and moves only the arm part.

19. The carrier device according to claim 5, wherein the linear moving mechanism includes a linear actuator connected to the arm part between the base and the arm part of the articulated robot and moves only the arm part.

20. The carrier device according to claim 6, wherein the linear moving mechanism includes a linear actuator connected to the arm part between the base and the arm part of the articulated robot and moves only the arm part.
